(19) United States
(12) Patent Application Publication
(10) Pub. No.: US 2011/0202367 A1
(43) Pub. Date: Aug. 18, 2011

(54) Healthcare Data Delivery System

(76) Inventor: David Frangioni, North Miami Beach, FL (US)

(21) Appl. No.: 12/705,947

(22) Filed: Feb. 15, 2010

(51) Int. Cl. G06Q 50/00; G06F 3/01; G06F 15/16; G06F 3/048; G06F 3/041

(52) U.S. Cl. 705/3; 715/865; 709/231; 715/764; 705/2; 345/173

(57) ABSTRACT

A system for providing preselected data to a human user who is a patient in a healthcare facility. The data can feature therapeutic audio content, informational content, and instructional content. The system can include a portable cart or other mobile platform on which a computer and touch screen display connected to the computer are installed. The computer can include a memory device capable of storing the therapeutic audio content. The touch screen display can feature control icons sized so as to be easily selected by manual manipulation by a user who is ill, impaired, or at least partially incapacitated. The touch screen display may also include a detachable transparent film affixed over a display surface. A method of the invention can include the step of decreasing audio volume to permit two-way communication between the user and a healthcare professional using the system.

### FIELD OF THE INVENTION

The invention relates to systems and methods for providing pre-selected data to a plurality of users. More particularly, the invention relates to systems and methods for using a mobile system to provide multimedia content and other types of data to a plurality of patient users in a healthcare facility.

### BACKGROUND

Audio content, such as sound recordings and particularly certain musical compositions or songs, is known to provide therapeutic effects to human subjects who are ill, impaired, incapacitated, mentally ill, emotionally disturbed, or experiencing or suffering from stress-induced symptoms. Therapeutic effects can include speech therapy, relaxation, stress reduction, emotion and mood enhancement, and biomedical responses such as reduced heart rate and blood pressure, production of beneficial hormones and other chemicals by the body that have curative, sedative, and mood-improving effects that facilitate nervous system function and a healthy circulatory system. Conventional audio playback devices, e.g., MP3 players and other portable audio devices, are capable of playing back music, audiobooks, and other content, however the conventional devices often include control icons shaped or sized so as to be difficult for a sick or elderly person to manipulate manually. The generally small size of the real and virtual controls buttons on these devices render them unsuitable for use in a healthcare facility where patients who are weak from illness as well as elderly patients who may be either or both physically weak and vision impaired are unable to effectively control the features of the conventional audio playback device.

Conventional audio playback devices are also generally small in size making them easily subject to theft or misplacement. The conventional devices are disadvantageous for use in a hospital, nursing or rest home, assisted living facility, and other healthcare settings and facilities because they do not include any disease prevention features. The sharing of conventional audio playback devices entails risks associated with the spread of pathogens such as bacteria and viruses that may be passed from one user to another through physical contact with the device.

Another disadvantage of conventional audio playback devices including those featuring combined telecommunications devices (e.g., combination cellular phone and MP3 players) is their lack of remote control features that would permit a doctor, nurse, or other healthcare professional to interrupt the playback of audio communicate to engage in bidirectional communication with the device's user. The conventional devices also lack any remote control features that would allow the healthcare professional to remotely select or change the audio content being listened to by the user. In the absence of this type of remote control feature, the healthcare professional is unable to monitor the user's device usage to ensure that the user (who is typically a patient) is listening to therapeutic audio content rather than music or other audio selected solely by the user, which may not be therapeutic in nature. Conventional audio playback devices also fail to provide a means for monitoring biofeedback data such as brain waves or heart rate and cannot be used by the healthcare professional to access and view medical records such as and including CT, MRI, and PET imaging scans.

Yet another disadvantage of conventional audio playback devices is the inability of portable types of the devices to play back sound or video content and recordings from a form other than a digital audio or video file of the type that is stored on a memory device of computer or other electronic data storage device. For example, conventional portable audio playback devices are incapable of playing sound or video recordings stored on physical media such as music encoded on a compact disc (CD) or a video stored on a digital video disc (DVD).

Healthcare professionals and other healthcare providers often work with many patients in a single day. Healthcare providers spend many hours with patients and patients' families and friends explaining a patient's diagnosis, medical condition, treatment, medication, post-diagnosis instructions, and recovery instructions. A need also exists for a system that permits a healthcare provider to provide the above information and instruction to a plurality of patients without requiring a personal explanation from the healthcare provider thereby freeing the healthcare provider to spend more time diagnosing and treating patients.

### SUMMARY

The invention can include systems and methods for delivering preselected data to a human user who is a patient in a healthcare facility. The user can be a human subject such as, for example, a patient in a hospital, a nursing home, or assisted living facility. The data can feature therapeutic audio content, informational content, and instructional content. The system can feature a mobile platform that may be a cart on wheels, which can be moved from room to room of the healthcare facility so that the system may be shared among multiple users. A computer featuring a data storage or memory device can be installed on the mobile platform. A touch screen display can be communicatively connected to the computer so that control icons or “buttons” may be displayed. The control features are designed so as to be capable of intuitive use by the user and may be located in fixed positions on a user interface of the system displayed on the touch screen display. The user can control some features of the system by manually pressing on the control icons displayed on the touch screen. The tactile input provided by the user is transmitted to the computer by the touch screen display and the computer translates the tactile input into control commands to control particular features of the system such as, for example, volume, power on and off, audio content selection for playback, bidirectional communication with a healthcare provider, video content selection (if available), and playback features (e.g., pause, stop, previous track, next track, rewind, fast forward, and play). To provide bidirectional communication between the user and the healthcare provider, the system can feature a telecommunications device that can be connected to a telecommunications network.

The user can listen to audio content by listening to a speaker device, which may be a pair of headphones worn over the user's ears. Video content may be played back and displayed to the user on the touch screen display.

To prevent the spread of communicable diseases, a detachable transparent film may be affixed over the surface of the touch screen display. As the system is moved from user to user, the detachable film may be removed and replaced between uses by different users. In this manner, pathogens such as bacteria and viruses, which would otherwise be present on the touch screen display due to contact by the user's hands and fingers with the display, can be prevented from being spread among users by removal, disposal, and replacement of the detachable film between uses.

The system also provides an advantage in that a patient user can receive information and instructions related to the patient's medical condition, diagnosis, treatment, medicines, and post-treatment care and recovery routines through the playback of multimedia content using the system. In this way, physicians and other healthcare providers can provide crucial information to patients while increasing efficiency and time management to reduce the amount of time providing explanations to each patient. The healthcare provider can use the time saved to treat more patients, spend additional time diagnosing and treating each patient, monitor each patient's treatment and recover, and conduct research or administrative tasks.

Accordingly, the invention can feature a system for providing access to data to a user for a fixed amount of time in a healthcare setting. The system can include a mobile platform, a computer, a touch screen display communicatively connected to the computer and installed on the mobile platform, and a speaker device. The computer can include a memory storage device that can store the data. The system may further include a communication device connected to a communications system that is capable of multi-directional transmission of voice and electronic data between the user and a healthcare provider.

In another aspect, the invention can feature the data being at least one content form selected from among: audio files, video files, animation files, text files, still image files, multimedia files, and interactive content files.

In another aspect, the invention can feature the system including at least one of an audio playback device, a video playback device, and a multimedia playback device.

In another aspect, the invention can feature the data including at least one software program or content form that is informational content.

In another aspect, the invention can feature the data including at least one software program or content form that is instructional content.

In another aspect, the invention can feature the data including at least one software program or content form that is therapeutic content.

In another aspect, the invention can feature the computer transmitting a plurality of touch screen buttons that are displayed on the touch screen display.

In another aspect, the invention can feature the touch screen buttons being sized and shaped to be easily visible to and touched by a vision-impaired, sick, or physically disabled user.

In another aspect, the invention can feature the computer being installed on the mobile platform.

In another aspect, the invention can feature the data being informational videos related to a medical treatment that a patient is to receive from a healthcare provider.

In another aspect, the invention can feature the data being instructional videos related to post-treatment recommendations pertaining to a patient's condition.

In another aspect, the invention can feature the mobile platform further including an adjustable mechanical support arm to which the touch screen display is connected.

In another aspect, the invention can feature the system further including a detachable transparent film capable of being affixed over the touch screen display screen.

In another aspect, the invention can feature streaming data being transmitted over the communications system to the communication device and played by the system.

In another aspect, the invention can feature the computer being capable of recording and transmitting to the healthcare provider usage data related to the user's use of features of the system.

In another aspect, the invention can feature the user's medical records being accessible from a remote database via the system.

In another aspect, the invention can feature the mobile platform of the system being movable so as to be capable of use by more than one user.

The invention also features a method for providing data to a plurality of patients in a healthcare facility. The method can include the step of providing a first patient of the plurality of patients use of a system for providing access to data for a predetermined period of time. The system of the method can include a mobile platform, a computer, a touch screen display communicatively connected to the computer and installed on the mobile platform, and a speaker device. The computer can include a memory storage device that can store the data. The system may further include a communication device connected to a communications system that is capable of multi-directional transmission of voice and electronic data between the user and a healthcare provider. The method can also include the step of allowing the first patient to access the data. At the expiration of the predetermined period of time, the method can include the step of relocating the mobile platform of the system for use by a second patient of the plurality of patients.

Another method of the invention can include the step of displaying visual data to the first patient on the touch screen display.

Another method of the invention can include the step of playing audio data to the first patient through the speaker device.

Another method of the invention can include the step of playing and displaying multimedia content to the first patient using the system.

Another method of the invention can include the step of permitting the first patient to interact with the system using the touch screen display.

Another method of invention can include automatically decreasing audio volume to permit two-way communication between the first patient and the healthcare provider.

Another method of the invention can include the step of providing information to the first patient related to at least one item of information selected from among: the first patient's medical condition and the first patient's medical treatment;

Another method of the invention can include the step of providing instruction to the first patient related to at least one item of instruction selected from among: the first patient's post-diagnosis treatment, the first patient's post-treatment care, and the first patient's recovery routine.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a front perspective view of a system of the invention.

FIG. 2 is a view of one embodiment of a screen shot displayed on a display screen of the invention of FIG. 1.

FIG. 3 is a rear perspective view of a display screen of the invention.

FIG. 4 is a front perspective view of an exemplary embodiment of a system of the invention.

FIG. 5 is an exemplary view of a screen shot displayed on a display screen of the invention of FIG. 4.

### DETAILED DESCRIPTION

The invention provides a system 10 for delivering preselected data to a user. The data can feature therapeutic audio content, informational content, and instructional content. The user can be a patient in a hospital, a healthcare clinic, a nursing home, a rest home, an assisted living facility, a hospice facility, or another healthcare facility; a person receiving home healthcare or end-of-life care; or a person or student receiving speech therapy, emotional or psychological counseling, undergoing stress management counseling, or receiving relaxation or meditative training or therapy. The user can also be a healthcare provider. The user's use of the system can be monitored by the healthcare provider who may instruct the user as to the system's proper use and control of its variety of features. The healthcare provider can be a physician, a nurse, a nurse assistant, a physician assistant, or another healthcare provider or professional.

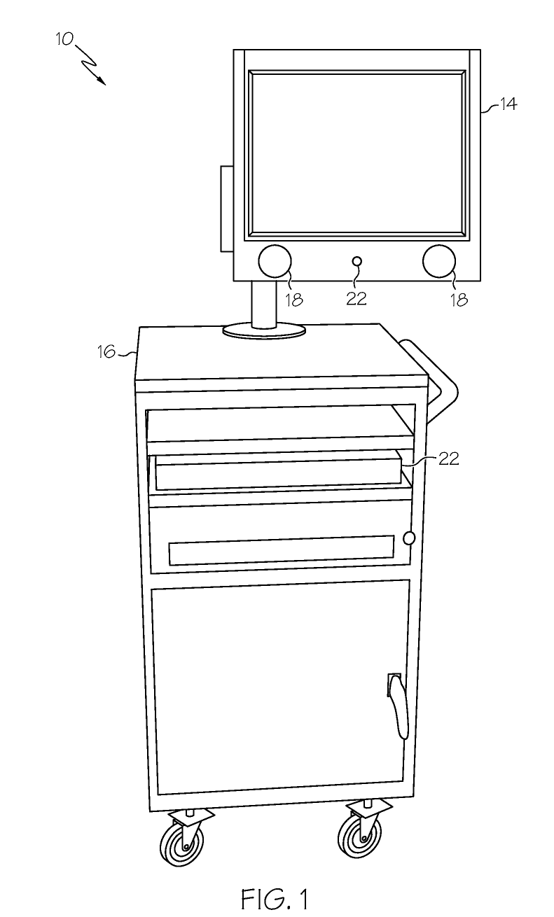

Referring now to FIG. 1, the system 10 can include a computer 12, a display screen 14, a mobile platform 16, and a speaker device 18. The computer 12 can feature a data storage or memory device on which data can be stored. The display screen 14 can be a touch screen display. A touch screen display 14 can be communicatively connected to the computer and may be used to display a user interface that is viewable by the user and with which the user may interact by manual manipulation of a plurality of touch screen controls 20 using the user's fingers and hand. The system 10 may further include a communication device 22 connected to a communications system or network that is capable of multi-directional transmission of voice and electronic data between the user and a healthcare provider. The communication device 22 can be the computer 12, another computer, or a telephone. The communication device can include a microphone capable of detecting and transmitting a human voice or other sound to the computer 12 or to the communication system for transmission to a remote location such as, for example to a healthcare provider in a room different than the user's room in a hospital.

The mobile platform 16 can be a cart, table, cabinet, or other movable platform capable of being moved from one location to another. The mobile platform 16 can include a horizontally planar top surface to which components of the system 10 may be secured and onto which other objects may be placed. The mobile platform 16 can include wheels, e.g., four wheels, for rolling over a floor surface. The mobile platform 16 can feature one or more shelves on which the electronic components or other objects of the system 10 can be installed or stored. In one embodiment, the mobile platform 16 may also include one or more cabinets inside of which electronic components of the system 10 and other objects may be installed or stored. The shelves and cabinets of the mobile platform 16 can be used to store media such as, for example, CDs, DVDs, cassettes, VHS tapes, minidiscs, flash drives, floppy discs, and other media storage apparatuses. The shelves and cabinets may also be used to store medical equipment, supplies, and medications. The mobile platform 16 can include mounting brackets or other fasteners that permit the touch screen display 14 and other components of the system 10 to be secured to the mobile platform. In one embodiment, the mobile platform 16 can include a keyboard tray for holding a keyboard that is communicatively connected to the computer 12. A mouse or other pointing device may also be communicatively connected to the computer 12 and placed on the keyboard tray.

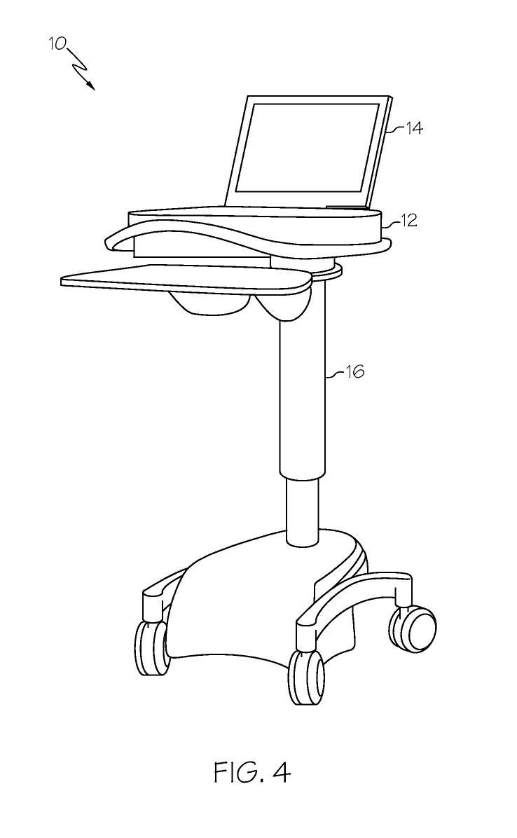

In an exemplary embodiment, the horizontally planar top surface of the mobile platform can be a work surface on which other items can be placed. For example, a keyboard, mouse, or other input devices communicatively connected to the computer can be featured by the system and positioned on the work surface. In one embodiment, the work surface can be 17 inches wide by 17 inches long, although any other size suitable for moving down hallways and from room to room may be used with the system. The horizontally planar top surface can serve as a point of attachment for the touch screen display 14. As shown in FIG. 4, the horizontally planar top surface and touch screen display can be connected to a base of the mobile platform by a height-adjustable stand. The base of the mobile platform can be, for example, 16.5 inches wide by 17 inches long so as to permit easy maneuvering around corners and through crowded rooms and corridors in a healthcare facility. Other sizes both smaller and larger than the aforementioned size for the base are contemplated by this invention. The height-adjustable stand can be mechanically or hydraulically operated. In another embodiment, the stand may not be adjustable with respect to its height. The mobile platform 16 and other components of the system can be constructed from lightweight materials.

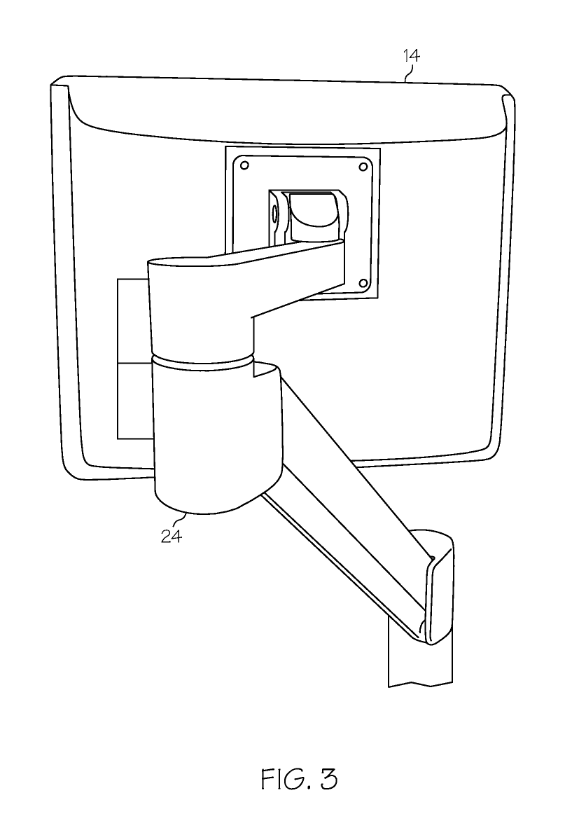

In an exemplary embodiment, the touch screen display 14 can be secured to the top surface or to a side surface of the mobile platform 16. The mobile platform 16 can feature a mechanical support arm 24, as shown in FIG. 3, that can be adjusted in two or more directions to achieve an elevation and angle of the touch screen display 14 that is more easily visible to a patient, and particularly, to a patient who is reposed in bed. The touch screen display 14 features a display surface capable of detecting physical contact by a user to manipulate system controls and buttons 20 and other interactive content displayed by the system 10. The touch screen display 14 can feature a swivel to permit the display screen to be turned or rotated on a vertical axis, e.g., 180 degrees or 360 degrees. The touch screen display 14 can also feature a tilt mechanism permitting the screen to be tilted for easier viewing depending on the location of the user with respect to the screen. The tilt mechanism can permit the display screen 14 to be tilted 0° to 15°, although greater degrees of tilting are also contemplated by the invention.

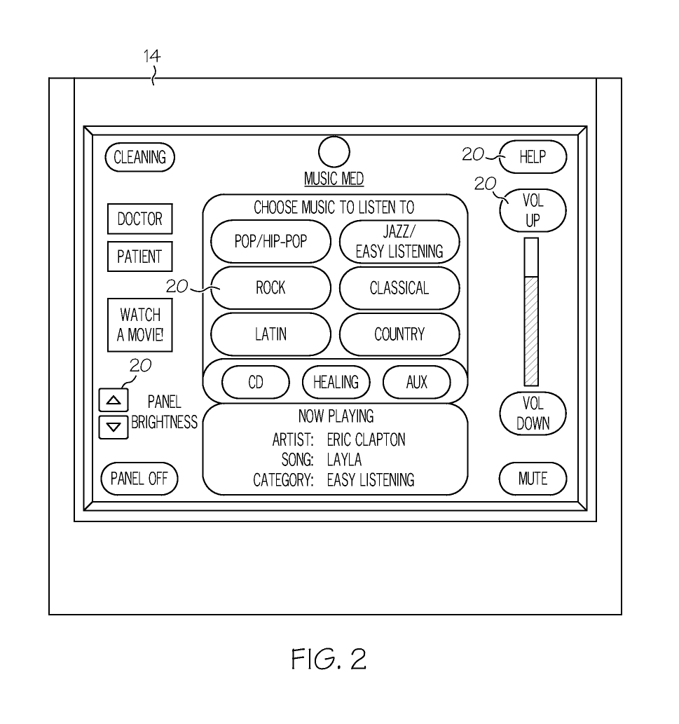

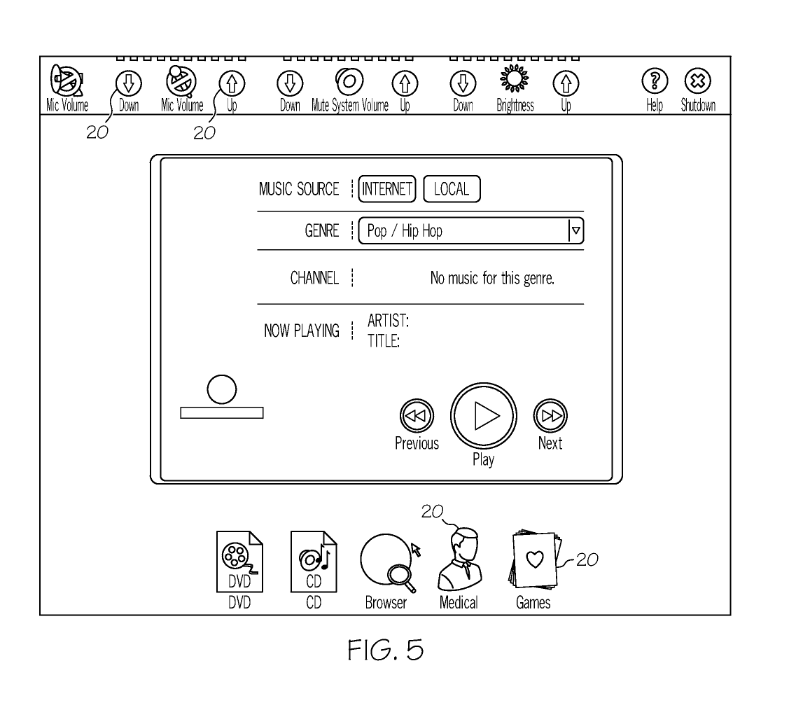

Examples of screen shots of the system showing exemplary touch screen system controls, buttons, and other interactive content are shown in FIGS. 2 and 5. The system may display touch screen controls and buttons on the touch screen display related to volume control, play, rewind, fast forward, a select or “enter” button for choosing content to be played, a

In an exemplary embodiment, to prevent the spread of communicable diseases caused by pathogens such as bacteria and viruses, a detachable transparent film may be affixed over the surface of the touch screen display 14. As the system 10 is moved from user to user, the detachable transparent film can be removed and replaced with a new detachable film between uses by different users. The used detachable transparent films can be disposed as garbage.

The computer 12 can include electrical and communicative connection ports for connecting the computer to a power source, the communications network, the communication device, the speaker, the touch screen display, and one or more playback devices such as, for example, an audio playback device, a video playback device, or a multimedia playback device. The computer 12 can also feature one or more drives for receiving and playing back media content stored on media storage apparatuses such as CDs, DVDs, and flash drives. The communications network can be a telecommunications network capable of accessing the Internet, a local area network, or any other type of telecommunications or data network. The computer 12 can include software installed thereon such as, for example, a media player. In an exemplary embodiment, the computer 12 can also feature software that is operable with a touch screen display 14 so as to permit control and operation of the system 10 by a user using touch screen buttons or controls 20.

In an exemplary embodiment, the computer 12 can be installed or positioned on the mobile platform 16. In another embodiment, each room in the healthcare facility can include a computer to which the mobile system can be connected as the system is moved between a plurality of patients.

The system 10 can include one or more audio output connections or jacks to which headphones or another audio listening device may be connected. The user may connect headphones to the computer 12 or to another playback device of the system 10 to listen to the therapeutic audio content such as, for example, music, or to other audio or multimedia content. By using the headphones to listen to the system's audio content, the playback of audio content does not disturb other patients who may be located in the same room as or near to the patient using the system.

The computer 12 also features the memory storage device capable of storing data such as, for example, informational data files, instructional data files, and therapeutic data files. Therapeutic data files can include music or recorded books. Patients may be given the option of selecting from among various genres or specific songs or artists for listening. Informational data files can feature text, still image, audio, video, animation, or multimedia information that a patient should know about his or her diagnosis, treatment, medications, and other health-related issues that may be general in nature or specific to the patient or the patient's condition. Instructional data files can include text, still image, audio, video, animation, or multimedia instructions that pertain to the patient's post-treatment care and recovery routine specific to the patient or the patient's condition.

The system 10 may also be capable of accessing and retrieving from a remote database a patient's medical records for display on the display screen 14. The remote database can be accessed via the communications system to which the system 10 is connected. The healthcare provider may view the patient's records while visiting the patient. The healthcare provider may also wish to show a patient his or her medical records during the discussion. For example, the healthcare provider could retrieve images for display on the display screen such as the patient's x-rays, CT scan images, MRI scan images, and PET scan images. In an exemplary embodiment, access to the remote database can be password-protected or otherwise secured for access only by authorized healthcare providers to ensure that a patient does not accidentally or intentionally access their own or another patient's medical records.

The computer 12 is also capable of receiving streaming data from the Internet or another network through its connection to the communications system. The streaming data can be immediately played for viewing and listening to by the user. Data may also be downloaded from the Internet or from another network for immediate playback or for storage on the computer's memory storage device. The memory storage device can be an internal hard drive, an external hard drive, a flash drive, or any other suitable data storage device.

The invention also features a method for providing data to a plurality of patients in a healthcare facility. A first patient of a plurality of patients can be provided use of a system such as, for example, the one described above, for providing access to data for a predetermined period of time. The method can allow the first patient to access the data during the allotted time, and at the expiration of the predetermined period of time, the system can be relocated for use by a second patient of the plurality of patients. The second patient can be located in the same room as or in a different room than the first patient. In this way, the plurality of patients can each receive an allotted or predetermined period of time coordinated by the healthcare provider within which to use the system and access the data preselected for each patient by the healthcare provider.

The method can include one or more of the steps of displaying visual data to the a patient on the touch screen display, playing audio data to a patient through the speaker device, and playing and displaying multimedia content to a patient using the system. The method can further include the step of permitting a patient to interact with the system using the touch screen display.

The method may also permit the audio volume to be decreased or muted automatically when a healthcare provider attempts to contact a patient using the system through the system's communication device and the connected communications system or network. This step of the method permits two-way communication between the first patient and the healthcare provider. The volume can be automatically increased once the conversation between the patient and healthcare provider has ended. In another embodiment, rather than decreasing the volume of the system, when a healthcare provider attempts to contact a patient using the system, playback of media content can be paused automatically and resumed when the conversation ends.

The method can include the step of providing information to a patient related to the patient's medical condition and treatment. The method can also feature the step of providing instruction to the patient related to the patient's post-diagnosis treatment, post-treatment care, and recovery routine.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A system for providing access to data to a user for a fixed amount of time in a healthcare setting, the system comprising:
a mobile platform;
a computer, the computer comprising a memory storage device, wherein the data is stored on the memory storage device;
a touch screen display communicatively connected to the computer and installed on the mobile platform;
a speaker device; and
a communication device connected to a communications system capable of multi-directional transmission of voice and electronic data between the user and a healthcare provider.

2. The system of claim 1, wherein the data comprises a content form of at least one type selected from the group consisting of: audio files, video files, animation files, text files, still image files, multimedia files, and interactive content files.

3. The system of claim 1, wherein the system further comprises at least one of an audio playback device, a video playback device, and a multimedia playback device.

4. The system of claim 1, wherein the data comprises at least one software program or content form comprising informational content.

5. The system of claim 1, wherein the data comprises at least one software program or content form comprising instructional content.

6. The system of claim 1, wherein the data comprises at least one software program or content form comprising therapeutic content.

7. The system of claim 1, wherein the computer transmits a plurality of touch screen buttons that are displayed on the touch screen display.

8. The system of claim 2, wherein the touch screen buttons are sized and shaped to be easily visible to and touched by a vision-impaired, sick, or physically disabled user.

9. The system of claim 1, wherein the computer is installed on the mobile platform.

10. The system of claim 1, wherein the data comprises informational videos related to a medical treatment that a patient is to receive from a healthcare provider.

11. The system of claim 1, wherein the data comprises instructional videos related to post-treatment recommendations pertaining to a patient's condition.

12. The system of claim 1, wherein the mobile platform further comprises an adjustable mechanical support arm to which the touch screen display is connected.

13. The system of claim 1, wherein the system further comprises a detachable transparent film capable of being affixed over the touch screen display screen.

14. The system of claim 1, wherein streaming data can be transmitted over the communications system to the communication device and played by the system.

15. The system of claim 1, wherein the computer is capable of recording and transmitting to the healthcare provider usage data related to the user's use of features of the system.

16. The system of claim 1, wherein the user's medical records are accessible from a remote database via the system.

17. The system of claim 1, wherein the mobile platform of the system is movable so as to be capable of use by more than one user.

18. A method for providing data to a plurality of patients in a healthcare facility, the method comprising the steps of:
(a) providing a first patient of the plurality of patients use of a system for providing access to data for a predetermined period of time, the system comprising:
a mobile platform;
a computer, the computer comprising a memory storage device, wherein the data is stored on the memory storage device;
a touch screen display communicatively connected to the computer and installed on the mobile platform;
a speaker device; and
a communication device connected to a communications system capable of multi-directional transmission of voice and electronic data between the user and a healthcare provider;
(b) allowing the first patient to access the data; and
(c) at the expiration of the predetermined period of time, relocating the mobile platform of the system for use by a second patient of the plurality of patients.

19. The method of claim 18, wherein step (b) of the method further comprises at least one step selected from the group consisting of:
(d) displaying visual data to the first patient on the touch screen display;
(e) playing audio data to the first patient through the speaker device;
(f) playing and displaying multimedia content to the first patient using the system;
(g) permitting the first patient to interact with the system using the touch screen display; and
(h) automatically decreasing audio volume to permit two-way communication between the first patient and the healthcare provider.

20. The method of claim 18, wherein step (b) of the method further comprises at least one step selected from the group consisting of:
(i) providing information to the first patient related to at least one item of information selected from the group consisting of: the first patient's medical condition and the first patient's medical treatment;
(j) providing instruction to the first patient related to at least one item of instruction selected from the group consisting of: the first patient's post-diagnosis treatment, the first patient's post-treatment care, and the first patient's recovery routine.
